(19) United States
(12) Patent Application Publication
(10) Pub. No.: US 2005/0033635 A1
(43) Pub. Date: Feb. 10, 2005

(54) Advertising and marketing method of internet site using magic code

(76) Inventor: Geon-Yong Jeon, Seoul (KR)

Correspondence Address: FARJAMI & FARJAMI LLP, 26522 LA ALAMEDA AVENUE, SUITE 360, MISSION VIEJO, CA, 92691, US

(21) Appl. No.: 10/486,174

(22) PCT Filed: Jun. 27, 2002
(86) PCT No.: PCT/KR02/01231

(30) Foreign Application Priority Data
Aug. 8, 2001 (KR) 2001/47823

(51) Int. Cl. G06F 17/60

(52) U.S. Cl. 705/14

(57) ABSTRACT

Disclosed is an advertising and marketing method of an Internet site using a magic code (10), in which the winning or losing status of a gift coupon (20) employing the magic code (10) is verified by overlapping the magic code (10) on a confirmation screen (60) provided by the Internet site and using an complementary color effect between the magic code (10) and the confirmation screen (60), thereby stimulating clients' interest, and improving advertising and promotion effects. In the advertising and marketing method of the Internet site using the magic code (10), close relationships with individual registered members are effectively maintained by a customer relationship management (CRM) system using a membership database (D/B), thereby allowing a company to plan a strategic marketing system and to maximize advertising and promotional effects, and effectively creating profitability.

### TECHNICAL FIELD

The present invention relates to an advertising and marketing method of an Internet site using a magic code, and more particularly to an advertising and marketing method of an Internet site using a magic code, in which the winning or losing status of a gift coupon employing the magic code is verified by overlapping the magic code on a confirmation screen provided by the Internet site, thereby stimulating clients' interest, and improving advertising and promotion effects. Further, the advertising and marketing method of the present invention effectively performs customer relationship management (CRM) using a membership database (D/B), thereby allowing a company to plan a strategic marketing system.

### BACKGROUND ART

Recently, as the number of users of various wireless communication networks including the Internet has increased tremendously, commercial activity through electronic commerce (EC) and purchases made using cyber cash have also increased. In order to keep up with these trends, on-line companies make a continuous effort to open sites on the Internet in order to capture the attention of Internet clients, and put forth all their energy to create various advertising and marketing methods.

Among the various advertising methods, a method of capturing the attention of clients by offering a free gift has been popularly and widely used. This method is carried out via lotteries, quizzes, surveys, games, and so forth.

However, all the conventional advertising methods are already generalized, thereby not meeting company's expectations and lowering the profits generated by the marketing activity. Accordingly, in order to overcome the aforementioned problem, an innovative profit model, which further stimulates clients' interest, has been demanded. After events for promoting the advertising effect of a company's Internet site are finished, the management of members of the Internet site tends to be neglected as well as not be customer-oriented, thereby not maintaining close relationships with the clients and consequently deteriorating the advertising effect.

### DISCLOSURE OF THE INVENTION

Therefore, the present invention has been made in view of the above problems, and it is an object of the present invention to provide an advertising and marketing method of an Internet site using a magic code, in which the winning or losing status of a gift coupon employing the magic code is verified by overlapping the magic code on a confirmation screen provided by the Internet site and using an complementary color effect between the magic code and the confirmation screen, thereby stimulating clients' interest, and improving advertising and promotion effects.

Further, it is another object of the present invention is to effectively maintain close relationships with individual registered members by a customer relationship management (CRM) system using a membership database (D/B), thereby allowing a company to plan a strategic marketing system and to maximize advertising and promotional effects, and effectively creating profitability.

In accordance with the present invention, the above and other objects can be accomplished by the provision of an advertising and marketing method of an Internet site using a magic code, comprising the steps of: S110) distributing to clients a gift coupon including a magic code with a hidden message using a complementary color effect and an identification number for confirming a free gift, wherein the magic code is detachably attached to the gift coupon and the identification number is printed on the gift coupon, and the hidden message includes a name of the free gift; S120) connecting a client obtaining the gift coupon including the magic code to a corresponding free gift-offering Internet site via wireless mobile communication equipment in order to confirm the gift; S130) verifying whether the client is a member of the Internet site; S140) displaying a main screen of a free gift event including a confirmation screen; S150) verifying the winning or losing status of the clients' gift coupon by detaching the magic code from the gift coupon and overlapping the detached magic code on the confirmation screen, wherein the hidden message is exposed to the outside by the complementary color effect between the hidden message and the confirmation screen; S160) inputting the name of the gift shown by exposing the hidden message and the identification number printed on the clients' gift coupon; S170) comparing the inputted identification number to the corresponding number stored by an identification number management database(D/B), thereby verifying whether the inputted name of the gift is equal to corresponding stored contents outputted from the identification number management database(D/B); S180) providing the corresponding gift to the client; and S190) analyzing data of individual clients via a customer relationship management (CRM) system using a membership management database(D/B) in which the data of the clients are stored in the step (S130) of verifying whether the client is a member of the Internet site.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view showing an embodiment of a magic code in accordance with the present invention;

FIG. 2 is a schematic view showing another embodiment of a magic code in accordance with the present invention;

FIG. 3 is a schematic view showing an embodiment of a gift coupon employing the magic code in accordance with the present invention;

FIG. 4 is a schematic view showing another embodiment of a gift coupon employing the magic code in accordance with the present invention;

FIG. 5 is a schematic block diagram showing a system environment for utilizing the magic code via an Internet in accordance with the present invention;

FIG. 6 is a schematic view of a main screen comprising a confirmation screen displayed according to the system environment of the present invention;

FIG. 7 is a flow chart illustrating an advertising and marketing method of an Internet site using the magic code in accordance with the present invention; and

FIG. 8 is a flow chart illustrating a process of offering a free gift using the magic code via the Internet in accordance with the present invention.

### BEST MODE FOR CARRYING OUT THE INVENTION

Now, preferred embodiments of the present invention will be described in detail with reference to the accompanying drawings. The following preferred embodiments have been made only for a better understanding of the present invention. Therefore, the present invention is not limited to these preferred embodiments, and various modifications, additions, and/or substitutions to these preferred embodiments are possible, without departing from the scope and spirit of the invention as disclosed in the accompanying claims.

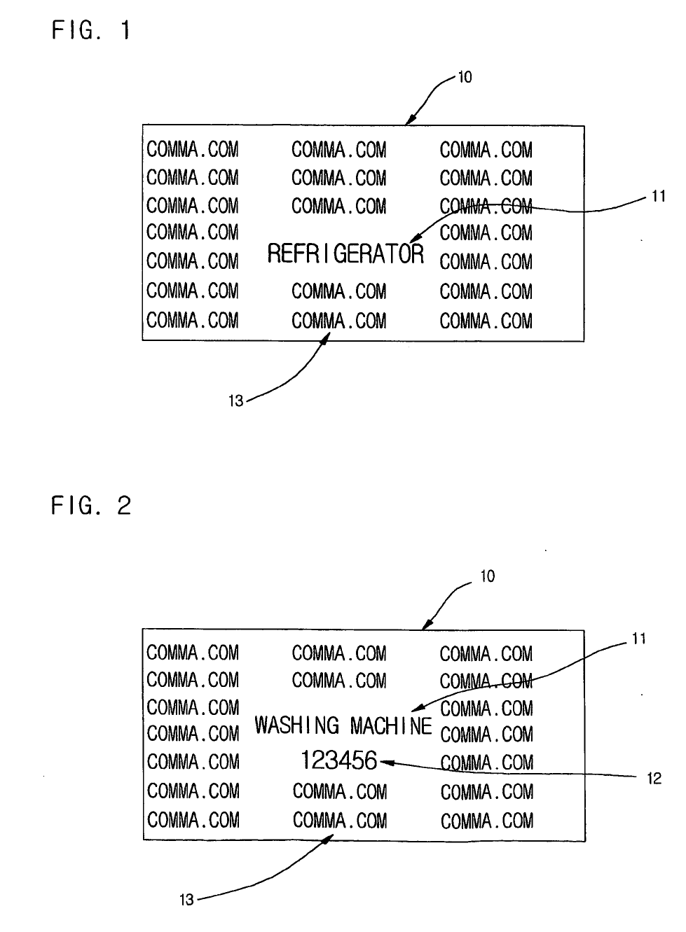

FIG. 1 is a schematic view showing an embodiment of a magic code in accordance with the present invention, and FIG. 2 is a schematic view showing another embodiment of a magic code in accordance with the present invention.

As shown in FIGS. 1 and 2, the magic code (10) of the present invention is a printed segment for exposing a hidden character or message. The magic code to (10) of the present invention is made of transparent and thin coating material such as polyester. A name (11) of an article to be offered as a free gift is printed on a surface of the coating material of the magic code (10) with fluorescent yellow ink. Herein, the name (11) of the article may be “WASHING MACHINE”, or “AIR CONDITIONER”. Alternatively, a message such as “NEXT TIME” may be printed on the coating material of the magic code (10).

Herein, as shown in FIG. 2, a predetermined identification number (12) in association with the free gift to be offered may be printed below the name (11) of the article on the coating material of the magic code (10) so as to more effectively verify the winning or losing status of a gift coupon employing the magic code (10). The identification number (12) may be printed also with fluorescent yellow ink.

After printing the name (11) of the article with the fluorescent yellow ink on the magic code (10), a domain name (13) of an Internet site for offering the free gift is printed throughout the magic code (10). Therefore, the name (11) of the article printed with the fluorescent yellow ink is hidden by the printed domain name (13) thereon. Herein, the domain name (13) is printed with fluorescent blue ink. The blue color of the domain name (13) is complementary with the yellow color of the name (11) of the article. The printed domain name (13) on the magic code (10) serves to indirectly advertise the Internet site to clients off-line.

Further, in order to prevent the hidden name (11) of the article or the hidden message by the domain name (13) of the Internet site from being easily exposed to the outside, the entire surface of the magic code (10) including the printed name (11) of the article and the printed domain name (13) of the Internet site is coated with water-based varnish.

In these preferred embodiments of the present invention, the name (11) of the article on the magic code (10) is coated with the fluorescent yellow ink and the domain name (13) of the Internet site on the magic code (10) is coated with the fluorescent blue ink, respectively. However, the name (11) of the article on the magic code (10) may be coated with fluorescent blue ink and the domain name (13) of the Internet site on the magic code (10) may be coated with fluorescent yellow ink. Moreover, any two complementary colors may be alternatively employed as the name (11) of the article and the domain name (13) of the Internet site on the magic code (10).

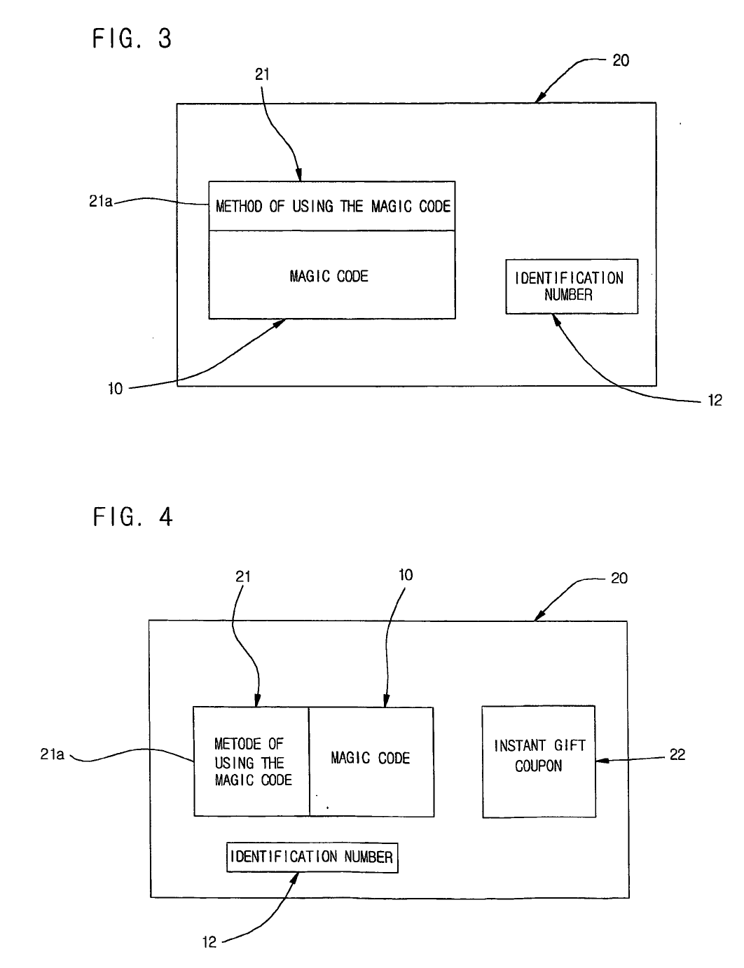

FIG. 3 is a schematic view showing an embodiment of a gift coupon employing the magic code in accordance with the present invention, and FIG. 4 is a schematic view showing another embodiment of a gift coupon employing the magic code in accordance with the present invention.

The aforementioned magic code (10) of the present invention is attached to a gift coupon (20) for participating in a free gift-offering event in order to more effectively promote the free gift-offering event and the advertising effect. As shown in FIG. 3, the gift coupon (20) employing the magic code (10) of the present invention comprises a gift unit (21) and the identification number (12). The gift unit (21) includes the magic code (10) and an instruction part (21a) for describing the method of using the magic code (10). The gift unit (21) is detachably attached to the gift coupon (20). The identification number (12) is separately printed on the gift coupon (20).

Herein, in order to further stimulate the clients' interest, the gift coupon (20) may offer another event, which takes place simultaneously with this free gift-offering event. For example, as shown in FIG. 4, a lottery card unit (22), of which the winning or losing status is determined by peeling off a scratch film using a coin, is further formed on the gift coupon (20). The lottery card unit (22) may be various types of lottery cards using numbers, marks, characters, figures, or combinations thereof. Instead of the lottery card unit (22), another identification number for verifying the winning or losing status of another event may be printed on the gift coupon (20).

The above-described gift coupon (20) of the present invention is distributed to the clients by various routes such as a free distribution, a distribution together with goods sold through an Internet site, and so forth.

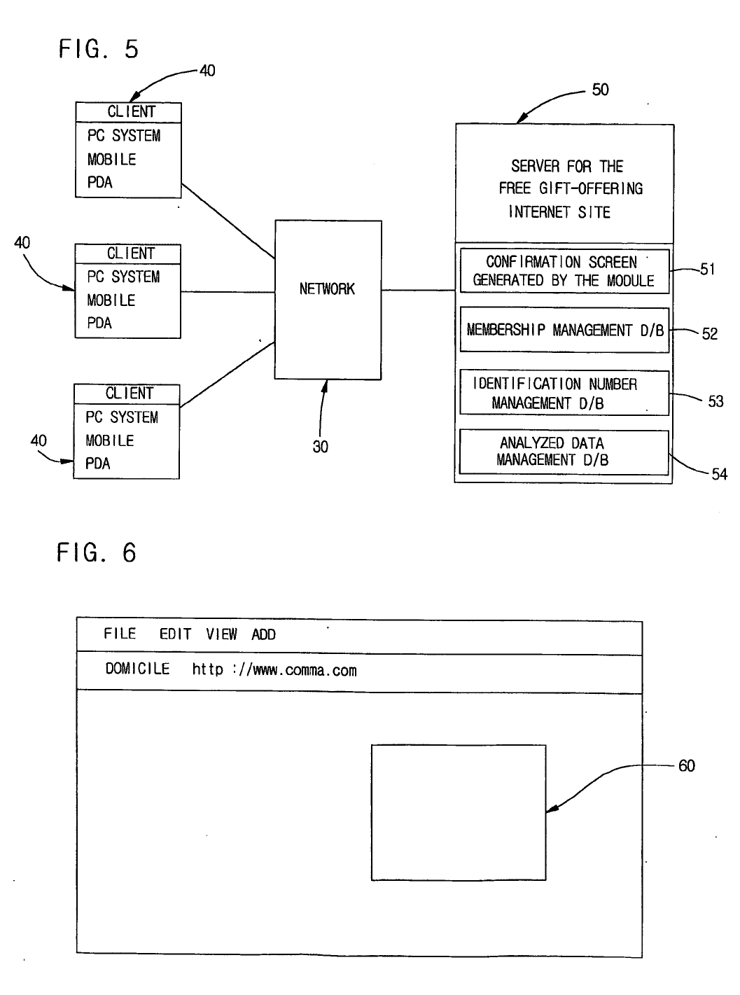

The clients obtaining the gift coupon (20) of the present invention must be connected to a system for verifying the winning or losing status of the obtained gift coupon (20) by the clients and advertising the free gift-offering Internet site to the clients. FIG. 5 is a schematic block diagram showing a system environment for utilizing the magic code via the Internet in accordance with the present invention. The system environment for utilizing the present invention on the Internet applies a general communication network (30) connectable to the Internet. That is, the system environment of the present invention comprises the network (30), individual clients' systems (40) connected to the network (30), and a server (50) for operating the free gift-offering Internet site. The server (50) is also connected to the network (30), thereby performing the free gift-offering event and advertising the free gift-offering Internet site to the clients.

Herein, each client's system (40) comprises a personal computer or wireless mobile communication equipment such as a cellular phone or a personal digital assistant (PDA).

The server (50) for operating the free gift-offering Internet site comprises a module (51) for generating a confirmation screen in blue color, a membership management database (52) for managing the clients, an identification number management database (53) for confirming the hidden message of the gift coupon and the identification number of the gift coupon, and an analyzed data management database (54) for managing data analyzed by a customer relationship management (CRM) system using the membership management database (52). Herein, the client confirms the hidden message on his/her obtained magic code via the confirmation screen generated by the module (51).

FIG. 6 is a schematic view of a main screen displayed on the Internet site by the module (51) for generating the confirmation screen (60). When the client is connected to the free gift-offering Internet site and selects an icon for instructing the free gift-offering event, the main screen of the free gift-offering event is displayed. The main screen comprises the blue confirmation screen (60) for confirming the hidden message of the magic code. Herein, as described above, the background color of the confirmation screen (60) is blue. However, since the background color of the confirmation screen (60) is complementary to the color of the hidden message of the magic code, the background color of the confirmation screen (60) may be variously changed according to the color of the hidden message of the magic code.

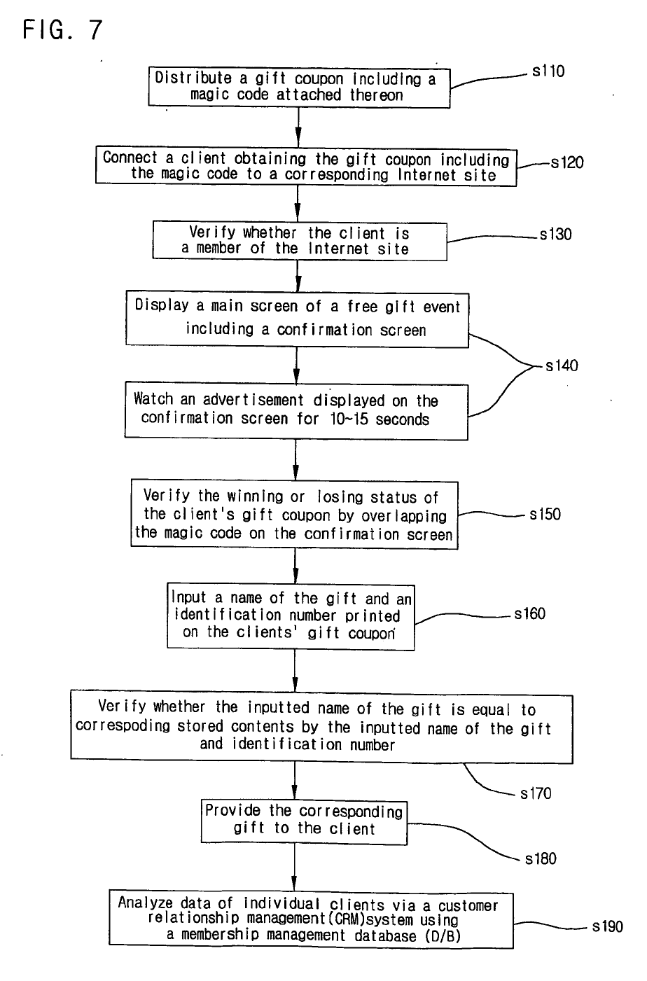

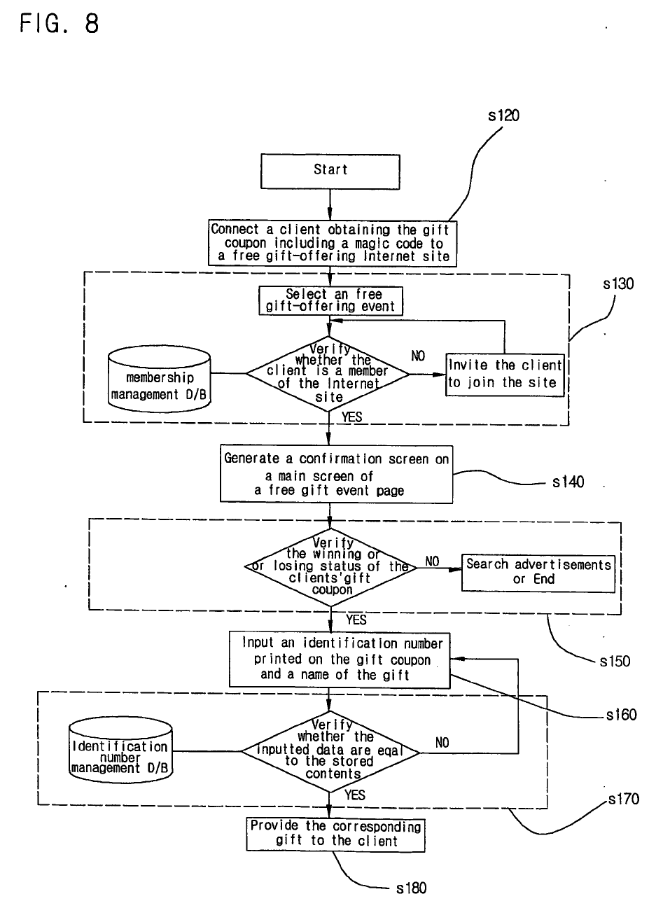

FIG. 7 is a flow chart illustrating an advertising and marketing method of an Internet site using the magic code in accordance with the present invention, and FIG. 8 is a flow chart illustrating a process of the free gift-offering event on the Internet using the magic code in accordance with the present invention.

With reference to FIGS. 7 and 8, hereinafter, the advertising and marketing method of the Internet site using the magic code and the process of the free gift-offering event on the Internet using the magic code are described in detail.

As shown in FIGS. 7 and 8, a new type of a gift coupon provided with the magic code having the hidden message is distributed to the clients off-line (S110). As described above, the gift coupon may be distributed to the clients by various routes such as a free distribution, a distribution together with goods sold through an Internet site, and so forth. Differently from the conventional free gift-offering events, an innovative free gift-offering event using the magic code is performed, thereby stimulating clients' interest.

After obtaining the gift coupon, a client is connected to the corresponding free gift-offering Internet site using the personal computer or the wireless mobile communication equipment such as the cellular phone or the personal digital assistant (PDA) so as to confirm the hidden message of his/her magic code (S120). In order to describe the method of using the magic code, the instruction part is printed on the gift coupon. Herein, the client has an interest in the free gift-offering event due to the new type of the gift coupon with the magic code, thus being induced to connect to the corresponding Internet site. Therefore, during the free gift-offering event, many advertisements can be continuously provided to the client.

After being connected to the corresponding free gift-offering Internet site, the client selects an icon for instructing the free gift-offering event. Then, the free gift-offering Internet site identifies whether the client is a member of this site or not (S130). Unless the client is a member of the site, the client is first invited to join the site. After joining the site as the member, the identification of the client is again carried out. If the client is already a member of the site, the client is directly connected to a free gift event page. Data of the client are stored in the membership management database(D/B).

After identifying the client using the membership management database(D/B), as shown in FIG. 6, the main screen of the free gift event page including the blue confirmation screen (60) is displayed (S140).

When the confirmation screen is displayed, the client overlaps the magic code of his/her gift coupon on the displayed confirmation screen, thereby verifying the winning or losing status of the clients' gift coupon (S150). Herein, the confirmation screen is luminous in blue by light generated by a monitor. The luminous blue color of the confirmation screen serves to illuminate the complementary yellow color of the hidden message on the magic code, thereby exposing the hidden message in gray tone from the blue color of the domain name of the Internet site on the magic code to the outside. The exposed hidden message of the magic code may represent the name of the gift to be provided to the client or only a message such as “NEXT TIME”. In case the clients' gift coupon is not a winning coupon, the client may search the corresponding free gift-offering Internet site. Otherwise, the client who does not want to search the corresponding gift-offering Internet site is allowed to leave the site.

In case the clients' gift coupon is a winning coupon by overlapping the magic code of the clients' gift coupon on the confirmation screen and exposing the hidden message of the magic code of the gift coupon, that is, the exposed hidden message represents a certain name of the gift, the client is required to input data such as the identification number printed on his/her gift coupon and the name of the gift (S160). Herein, as shown in FIG. 4, in case the gift coupon (20) comprises the lottery card unit (22), the client separately inputs the name of the gift of the gift coupon (20) and the name of another gift to be obtained by the lottery card unit (22).

Then, the gift to be obtained by the client is confirmed using the inputted identification number and the inputted name of the gift (S170). Herein, the free gift-offering Internet site compares the inputted identification number of the clients' gift coupon to the corresponding number stored in the identification number management database(D/B), thereby verifying whether the inputted name of the gift by the client is equal to the corresponding contents.

After the above-described steps of inputting data and confirming the inputted data, the corresponding gift is provided to the client (S180).

Using the membership management database(D/B), in which data of members are stored during the step (S130), the customer relationship management (CRM) is carried out (S190). Herein, customer relationship management (CRM) defines a type of management system for planning a One-to-One marketing with individual members using stored personal data of the registered members and continuously maintaining close relationships with the members, thereby analyzing obtained results and applying the analyzed results to a new profit model in business management. For example, individual tastes and/or tendencies of the registered members through the free gift-offering event of the Internet site are analyzed, processed, and stored in a database. The analyzed data of the individual members are applied to the new profit model in the business management. Herein, all data analyzed by the customer relationship management (CRM) system are processed and stored in the analyzed data management database(D/B), thereby being used in planning a strategy of offensive marketing and advertising.

### INDUSTRIAL APPLICABILITY

As apparent from the above description, the present invention provides an advertising and marketing method of an Internet site using a magic code. In accordance with the present invention, the winning or losing status of a gift coupon employing the magic code is verified by overlapping the magic code on a confirmation screen provided by the Internet site and using an complementary color effect between the magic code and the confirmation screen, thereby stimulating clients' interest, and improving advertising and promotion effects.

Further, the advertising and marketing method of the present invention effectively maintains close relationships with individual registered members by a customer relationship management (CRM) system using a membership database (D/B), thereby allowing a company to plan a strategic marketing system and to maximize advertising and promotional effects, and effectively creating profitability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An advertising and marketing method of an Internet site using a magic code, said method comprising the steps of:
S110) distributing to clients a gift coupon (20) including a magic code (10) with a hidden message using a complementary color effect and an identification number (12) for confirming a free gift, wherein the magic code is detachably attached to the gift coupon and the identification number (12) is printed on the gift coupon (20), and the hidden message includes a name (11) of the free gift;
S120) connecting a client obtaining the gift coupon (20) including the magic code (10) to a corresponding free gift-offering Internet site via wireless mobile communication equipment in order to confirm the gift;
S130) verifying whether the client is a member of the Internet site;
S140) displaying a main screen of a free gift event including a confirmation screen (60);
S150) verifying the winning or losing status of the clients' gift coupon (20) by detaching the magic code (10) from the gift coupon (20) and overlapping the detached magic code (10) on the confirmation screen (60), wherein the hidden message is exposed to the outside by the complementary color effect between the hidden message and the confirmation screen (60);
S160) inputting the name (11) of the gift shown by exposing the hidden message and the identification number (12) printed on the clients' gift coupon (20);
S170) comparing the inputted identification number (12) to the corresponding number stored by an identification number management database(D/B), thereby verifying whether the inputted name (11) of the gift is equal to corresponding stored contents outputted from the identification number management database(D/B);
S180) providing the corresponding gift to the client; and
S190) analyzing data of individual clients via a customer relationship management (CRM) system using a membership management database(D/B) in which the data of the clients are stored in the step (S130) of verifying whether the client is a member of the Internet site.

2. The advertising and marketing method of an Internet site using a magic code as set forth in claim 1, wherein said magic code (10) of the gift coupon (20) in the step (S110) comprises:
the name (11) of the gift printed on the magic code (10) in a designated colored fluorescent ink; and
a domain name (13) of the Internet site printed throughout the magic code (10) with a complementary colored fluorescent ink to the color of the name (11) of the gift,
wherein the printed name (11) of the gift on the magic code (10) is hidden by the printed domain name (13) of the Internet site on the magic code (10).

3. The advertising and marketing method of an Internet site using a magic code as set forth in claim 1, wherein said wireless mobile communication equipment is a personal computer (PC), a cellular phone, or a personal digital assistant (PDA).
